(19) United States
(12) Patent Application Publication
(10) Pub. No.: US 2005/0198483 A1
(43) Pub. Date: Sep. 8, 2005

(54) Conversion apparatus and method thereof

(76) Inventors: Hyun-Woo Park, Suwon-si (KR); Dong-Hoon Lee, Suwon-si (KR); Keun-Cheol Hong, Suwon-si (KR)

Correspondence Address: HARNESS, DICKEY & PIERCE, P.L.C., P.O. BOX 8910, RESTON, VA, 20195, US

(21) Appl. No.: 11/060,307

(22) Filed: Feb. 18, 2005

(30) Foreign Application Priority Data
Feb. 20, 2004 (KR) 2004-11323

(51) Int. Cl. G06F 7/36

(52) U.S. Cl. 712/300

(57) ABSTRACT

In the method of conversion, at least one of a protocol and a data format may be changed without requiring software processing. A data conversion apparatus is provided which may convert between at least one of a protocol and a data format without requiring software processing. A data processing system is provided including the data conversion apparatus.

### BACKGROUND OF THE INVENTION

This application claims the priority of Korean Patent Application No. 2004-11323, filed on Feb. 20, 2004, in the Korean Intellectual Property Office, the disclosure of which is incorporated herein in its entirety by reference.

1. Field of the Invention

The present invention relates generally to a conversion apparatus and method thereof, and more particularly, to a conversion apparatus and method for converting data between formats and protocols.

2. Description of the Related Art

FIG. 1 illustrates a timing diagram of a transmission and reception of 32-bit data in units of 8 bits.

Referring to FIG. 1, when a 32-bit data DATA D[31:0] is transmitted in units of 8 bits, a big-endian system may transmit or receive data based on an address ADD[1:0] in an order from D[31:24] (i.e., the 8 most significant bits) to D[7:0] (i.e., the 8 least most significant bits), while a little-endian system may transmit or receive data according to an address ADD[1:0] in an order from D[7:0] to D[31:24].

FIG. 2 illustrates a timing diagram of a transmission and receipt of 32-bit data in units of 16 bits.

Referring to FIG. 2, when 32-bit data D[31:0] is transmitted in units of 16 bits, the big-endian method may transmit or receive data based on an address ADD[1:0] in an order from 16-bit data D[31:16] (i.e., the 16 most significant bits) to 16-bit data D[15:0] (i.e., the 16 least significant bits), while the little-endian system may transmit or receive data D[31:0] based on an address ADD[1:0] in an order from 16-bit data D[15:0] to 16-bit data D[31:16]. When a memory with a 16-bit width is used for the data transfer, each of the little and/or big endian systems may store data as shown in FIG. 2 based on the address ADD[1:0].

FIG. 3 illustrates a timing diagram of a transmission and receipt of 16-bit data in units of 8 bits.

Referring to FIG. 3, when 16-bit data is transmitted in units of 8 bits, the big-endian method may transmit data based on an address ADD[1:0] from D[15:8] to D[7:0] while the little-endian system may transmit data based on an address ADD[1:0] from D[7:0] to D[15:8].

When data used in a big-endian system or data used in a little-endian system is used in a big-endian system, software may be required to convert between the two formats. As more data requires conversion between the big/little endian formats, the software load (i.e., size and processing requirements) may increase. Thus, the additional software load required for a data format conversion may slow a system performing a software data conversion.

### SUMMARY OF THE INVENTION

An exemplary embodiment of the present invention is a data conversion apparatus, including a protocol conversion device for receiving a first data with a first protocol at one or more of a plurality of input ports and converting the received first data into a second protocol without requiring software processing.

Another exemplary embodiment of the present invention is a data conversion apparatus, including a first endian converter for converting first data with a first data format and a first protocol into a second data format in response to a control signal, a second endian converter for converting second data with a second data format and the first protocol into a first data format in response to the control signal, and a protocol converter for converting at least one of the first and second data from a second protocol to the first protocol.

Another exemplary embodiment of the present invention is a data conversion apparatus including a first endian converter for performing at least one of converting big-endian data into little-endian data and not performing a data format conversion based on a control signal, a second endian converter for performing at least one of converting little-endian data into big-endian data and not performing a data format conversion based on the control signal, and a protocol converter for converting first big-endian data complying with a first protocol into first big-endian data complying with a second protocol, outputting the converted first big-endian data to the first endian converter, converting second little-endian data complying with the second protocol into second little-endian data complying with the first protocol, and outputting the converted second little-endian data to the second endian converter.

Another exemplary embodiment of the present invention is a data processing system, including a data conversion apparatus for outputting first data including at least one of a first data transmission format and a second data transmission format, and an external system for transferring second data with the data conversation apparatus, the second data including at least one of the first data transmission format and the second data transmission format.

Another exemplary embodiment of the present invention is a method for converting data transmission formats, including generating a control signal based on a data transmission format used by an external system, and configuring a first data transmission format conversion circuit to convert received first data including a first data transmission format into a second data transmission format in response to a control signal.

Another exemplary embodiment of the present invention is a method of data format conversion, including receiving data with a first data format, and converting the data into a second data format without requiring software processing.

Another exemplary embodiment of the present invention is a method of data protocol conversion, including receiving data with a first data protocol, and converting the data into a second data protocol without requiring software processing.

### BRIEF DESCRIPTION OF THE DRAWINGS

The present invention will become more apparent by describing in detail exemplary embodiments thereof with reference to the attached drawings in which:

FIG. 1 illustrates a timing diagram of a transmission and reception of 32-bit data in units of 8 bits.

FIG. 2 illustrates a timing diagram of a transmission and receipt of 32-bit data in units of 16 bits.

FIG. 3 illustrates a timing diagram of a transmission and receipt of 16-bit data in units of 8 bits.

FIG. 4 illustrates a block diagram of a data processing system according to an exemplary embodiment of the present invention.

FIG. 5 illustrates a block diagram of a data conversion apparatus according to another exemplary embodiment of the present invention.

FIG. 6 illustrates a flowchart of a method for converting data between endian formats according to another exemplary embodiment of the present invention.

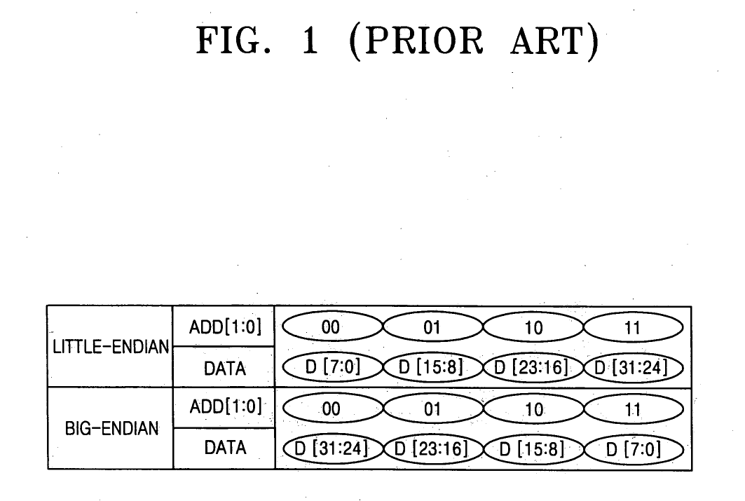

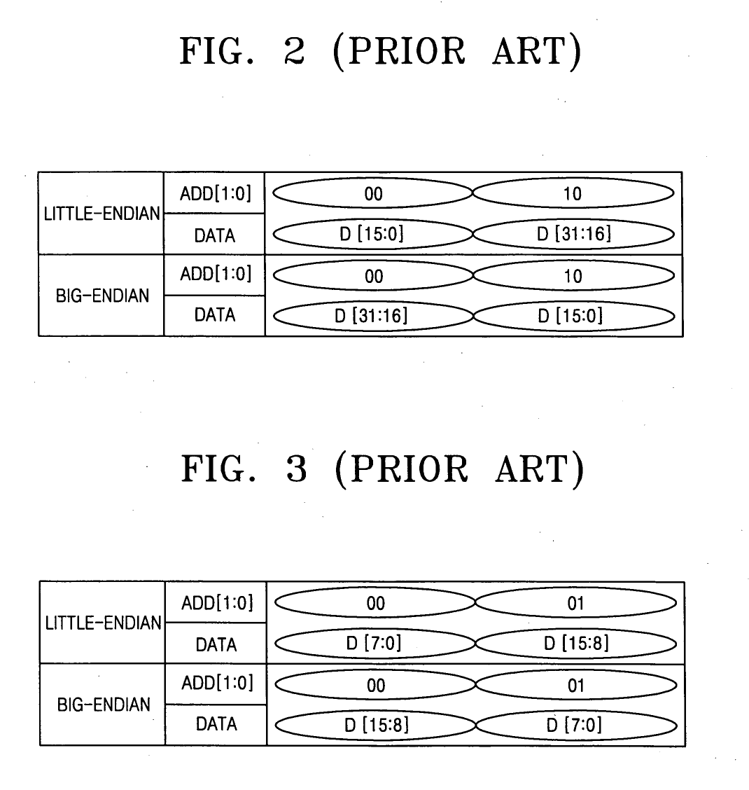

### DETAILED DESCRIPTION OF THE INVENTION

Hereinafter, exemplary embodiments of the present invention will be described in detail with reference to the accompanying drawings.

In the Figures, the same reference numerals are used to denote the same elements throughout the drawings.

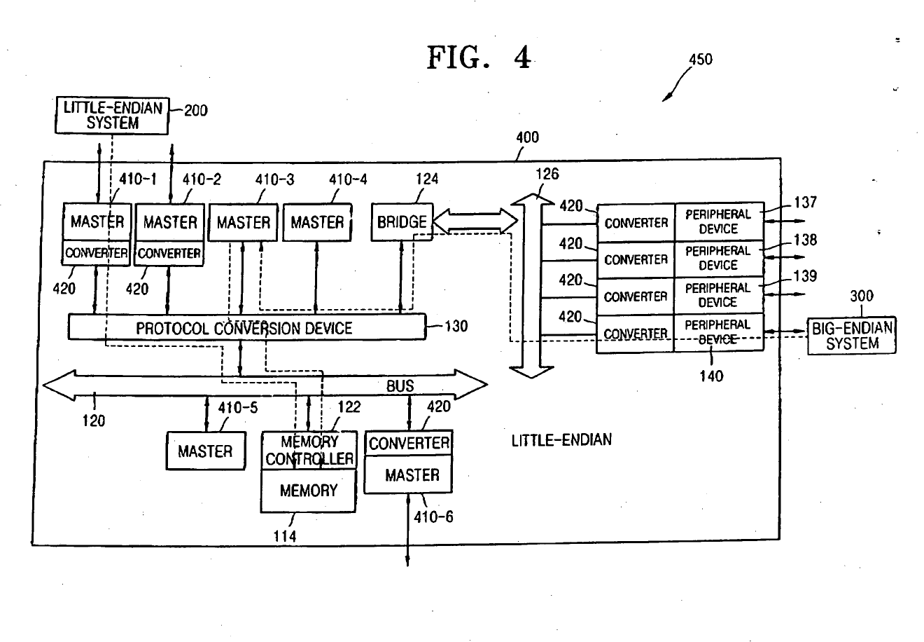

FIG. 4 illustrates a block diagram of a data processing system 450 according to an exemplary embodiment of the present invention.

In another exemplary embodiment of the present invention, the data processing system 450 may include a little-endian system 200, a data processing apparatus 400, and a big-endian system 300.

In another exemplary embodiment of the present invention, the data processing apparatus 400 may be included within a digital TV and/or a set-top box.

In another exemplary embodiment of the present invention, the data processing apparatus 400 may be implemented as a system-on-chip (SOC).

In another exemplary embodiment of the present invention, the little-endian system 200 and the data processing apparatus 400 may process data complying with a little-endian format (hereinafter referred to as little-endian data) and the big-endian system 300 may process data complying with a big-endian format (hereinafter referred to as big-endian data).

In another exemplary embodiment of the present invention, the big-endian system 300 and/or the little-endian system 200 may be connected to at least one of the modules 410-1/410-2/410-3/410-4/410-5/410-6 and/or to at least one peripheral device (e.g. peripheral device 137/138/139/140, etc.) connected to the data processing apparatus 400.

In another exemplary embodiment of the present invention, the data processing apparatus 400 may include a memory 114, a first system bus 120, a memory controller 122, a bridge 124, a second system bus 126, a protocol conversion device 130, modules 410-1/410-2/410-3/410-4/410-5/410-6, and/or a plurality of peripheral devices 137/138/139/140. Each of the modules 410-1/410-2/410-3/410-4/410-5/410-6 may be either a master or a slave. The data processing apparatus 400 may include a plurality of bus protocols (e.g., open core protocol (OCP), Advanced Microcontroller Bus Architecture (AMBA) protocol, etc . . . ).

In another exemplary embodiment of the present invention, at least one of the plurality of modules 410-1/410-2/410-3/410-4/410-5/410-6 may store little-endian data in the memory 114.

In another exemplary embodiment of the present invention, referring to FIG. 4, the first system bus 120 may include an OCP. In another exemplary embodiment of the present invention, the first system bus 120 may be a SONIC OCP bus.

In another exemplary embodiment of the present invention, the memory controller 122 may control each of the plurality of modules 410-1/410-2/410-3/410-4/410-5/410-6 and/or the plurality of peripheral devices 137/138/139/140 to transfer little-endian data to and from the memory 114.

In another exemplary embodiment of the present invention, first and second system buses 120 and 126 may be connected to each other through a bridge 124.

In another exemplary embodiment of the present invention, the second system bus 126 may include an AMBA protocol.

In another exemplary embodiment of the present invention, a protocol conversion device 130 may convert signals complying with a first protocol supported by the first system bus 120 into signals complying with a second protocol supported by the second system bus 126.

In another exemplary embodiment of the present invention, the protocol conversion device 100 may convert signals complying with the second protocol supported into signals complying with the first protocol.

In an example, each of the modules 410-1/410-2/410-3/410-4, the bridge 124 and each of the plurality of peripheral devices may use the AMBA protocol, while each of the modules 410-5/410-6 may use the OCP.

In another exemplary embodiment of the present invention, each of the modules 410-1/410-2/410-3/410-4/410-5/410-6 may transfer data with a system externally connected to the data processing apparatus 400 through at least one of a plurality of data conversion apparatuses 420.

In another exemplary embodiment of the present invention, the plurality of peripheral devices 137/138/139/140 may transfer data with the externally connected system through at least one of the data conversion apparatuses 420.

In another exemplary embodiment of the present invention, the modules 410-3/410-4/410-5 and the bridge 124 may include respective cores (not shown) and at least one protocol conversion device. An example of the protocol conversion device may include a wrapper.

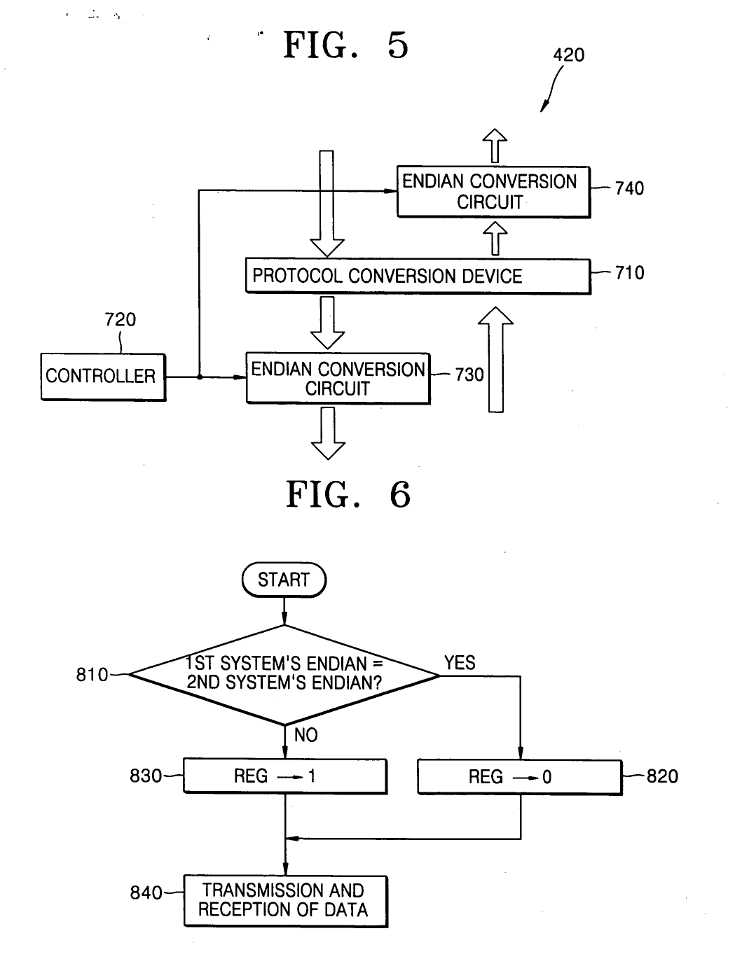

FIG. 5 illustrates a block diagram of a data conversion apparatus 420 according to another exemplary embodiment of the present invention.

In another exemplary embodiment of the present invention, referring to FIG. 5, the data conversion apparatus 420 may include a protocol conversion device 710, a controller 720, a first endian converter 730, and/or a second endian converter 740.

In another exemplary embodiment of the present invention, the protocol conversion device 710 may include two pairs of ports (not shown), each pair including an input port and an output port.

In another exemplary embodiment of the present invention, the protocol conversion device 710 may convert endian data according to the first protocol input into endian data according to the second protocol.

In another exemplary embodiment of the present invention, the endian data according to the first protocol may be received through one of the plurality of the input ports.

In another exemplary embodiment of the present invention, the endian data according to the second protocol may be output through one of the plurality of the output ports.

In another exemplary embodiment of the present invention, the controller 720 may include at least one programmable register.

In another exemplary embodiment of the present invention, the controller 720 may generate a control signal for controlling a data format conversion (i.e., the first endian converter 730 and the second endian converter 740 may convert data transmission formats from a big-endian to a little-endian format and/or a little-endian format to a big-endian format in response to the control signal).

In another exemplary embodiment of the present invention, the control signal may be an output of at least one register.

In another exemplary embodiment of the present invention, a user may update (i.e., set) the register of the controller 720 when the system is configured during an initial stage and/or when the external system 200 and/or 300 is changed (e.g., when an external system changes endian formats), thereby controlling the operation of each of the endian converters 730/740. For example, if a user knows the data transmission format (e.g., big-endian, little-endian, etc.) used in each of the systems 200/300/400, the user may control the endian converters 730/740 in order to increase system efficiency (e.g., by associating a conversion with a data transmission format of the systems 200/300/400).

In another exemplary embodiment of the present invention, the first and second endian converters 730 and 740 may be examples of a data transmission format conversion circuit.

In another exemplary embodiment of the present invention, the first endian converter 730 may receive big-endian data (i.e., data in a big-endian format) from the protocol conversion device 710. The first endian converter 730 may convert the received big-endian data into little-endian data in response to a control signal, and may output the converted data. Alternatively, the first endian converter 730 may receive little-endian data through the output port of the protocol conversion device 710. The first endian converter 730 may output the little-endian data without a conversion (i.e., in a little-endian format) in response to the control signal. Thus, the first endian converter 730 may output data in a little-endian format irrespective of the received format of the data.

In another exemplary embodiment of the present invention, the second endian converter 740 may receive little-endian data from the protocol conversion device 710. The second endian converter 740 may convert the received little-endian data into big-endian data in response to a control signal, and may output the converted data. Alternatively, the second endian converter 740 may receive big-endian data from the protocol conversion device 710. The second endian converter 740 may output the big-endian data without a conversion in response to the control signal. Thus, the second endian converter 740 may output data in a big-endian format irrespective of the received format of the data.

In another exemplary embodiment of the present invention, referring to FIGS. 4 and 5, in the memory 114 may store little-endian data received from the little-endian system 200 and big-endian data received from the big-endian system 300.

In another exemplary embodiment of the present invention, since each circuit (e.g. 410-1, 410-2, etc.) in the data processing apparatus 400 may process little-endian data, the user may set the controller 720 to enable the data conversion apparatus 420 of at least one of the peripheral devices 137/138/139/140 (e.g., peripheral device 140) to perform an endian format conversion of data. The user may also set the controller 720 such that the data conversion apparatus 420 of the module 410-1 may not perform an endian format conversion.

In another example, when the controller 720 is implemented as a register, if the data value stored in the register (i.e., controller 720) is at a first logic level (i.e., one of a high logic level ‘1’ and a low logic level ‘0’), each of the endian conversion circuits 730 and 740 may perform an endian format conversion of data. If the data value stored in the register 720 is at a second logic level (i.e., one of a high logic level ‘1’ and a low logic level ‘0’), each of the endian conversion circuits 730 and 740 may pass (i.e., receive and output) the received data without a format conversion.

In another example, if the big-endian data from the big-endian system 300 is received by the protocol conversion device 710 of the data conversion apparatus 420 of the peripheral device 140, the protocol conversion device 710 may convert the big-endian data complying with a first protocol (e.g., OCP, AMBA, etc . . . ) used or supported by the big-endian system 300 into big-endian data complying with a second protocol used or supported in the data processing apparatus 400. The protocol conversion device 710 may output the converted big-endian data to the endian conversion circuit 730.

In another exemplary embodiment of the present invention, the endian conversion circuit 730 may convert the big-endian data received from the protocol conversion circuit 710 into little-endian data and may store the converted little-endian data in the memory 114 through an internal data path. For example, the internal data path may include bus 126, bridge 124, protocol conversion device 130, module 410-3, protocol conversion device 130, first system bus 120, and/or memory controller 122. It is understood that the internal data path may include any path through any element of the data processing apparatus 400.

In another example, if the little-endian data output from the memory 114 is transmitted to the data conversion apparatus 420 of the peripheral device 140 through the internal data path, the protocol conversion device 710 may convert the little-endian data complying with a protocol used in the data processing apparatus 400 into little-endian data complying with the first protocol used in the big-endian system 300. The protocol conversion device 710 may output the converted little-endian data to the endian conversion circuit 740.

In another exemplary embodiment of the present invention, the endian conversion circuit 740 may convert the little-endian data output from the protocol conversion device 710 into big-endian data and may output the converted big-endian data to the big-endian system 300.

In another exemplary embodiment of the present invention, the little-endian data output from the little-endian system 200 to the module 410-1 may be received by the protocol conversion device 710.

In another exemplary embodiment of the present invention, the protocol conversion device 710 may convert the little-endian data complying with a third protocol used in the little-endian system 200 to little-endian data complying with the second protocol used in the data processing apparatus 400. The protocol conversion device 710 may output the converted little-endian data to the endian conversion circuit 730.

In another exemplary embodiment of the present invention, since the endian conversion circuit 730 may be inactivated in response to a control signal (e.g., the control signal may have a high logic state ‘1’ or a low logic state ‘0’) output from the controller 720 (i.e., the register), the little-endian data output from the protocol conversion device 710 may be stored without a format conversion in the memory 114 through the internal data path (e.g., the internal data path may include the protocol conversion device 130, the first system bus 120 and the memory controller 122).

In another exemplary embodiment of the present invention, when the little-endian system 200 reads the little-endian data stored in the memory 114, the little-endian data read from the memory 114 may be received by the protocol conversion device 710 through an internal data path of the data processing apparatus 400.

In another exemplary embodiment of the present invention, the protocol conversion device 710 may convert the little-endian data complying with the second protocol used in the data processing apparatus 400 into little-endian data complying with the third protocol used in the little-endian system 200. The protocol conversion device 710 may output the converted little-endian data to the endian conversion circuit 740.

In another exemplary embodiment of the present invention, the first, second and third protocols may include any well-known protocol (e.g., OCP, AMBA, etc.).

In another exemplary embodiment of the present invention, since the endian conversion circuit 740 is inactivated (i.e. the endian conversation circuit 740 does not perform a conversion) in response to a control signal (e.g., the control signal may have a high logic state ‘1’ or a low logic state ‘0’) output from the controller 720, the little-endian data output from the protocol conversion device 710 may be output without a conversion to the little-endian system 200.

In another exemplary embodiment of the present invention, if the little-endian system 200 is replaced by a big-endian system (e.g., big-endian system 300 or any other big-endian system), the controller 720 may be programmed (i.e., set, configured, etc., ) to output a control signal at the first logic state (e.g., the control signal may have a high logic state ‘1’ or a low logic state ‘0’).

In another exemplary embodiment of the present invention, the endian conversion circuit 730 may convert big-endian data into little-endian data and/or the endian conversion circuit 740 may convert little-endian data into big-endian data.

In another exemplary embodiment of the present invention, the endian conversion circuit 730 and/or the endian conversion circuit 740 may perform a conversion in response to a control signal.

In another exemplary embodiment of the present invention, when the data processing apparatus 400 including the data conversion apparatus 420 transfers (i.e., receives and/or outputs) data with a system and/or device including big-endian data and/or little-endian data, the endian data (i.e., either big-endian and/or little-endian) may be transmitted and received by the data conversion apparatus 420 without processing incurred by processing software.

FIG. 6 illustrates a flowchart of a method for converting data between endian formats according to another exemplary embodiment of the present invention.

In another exemplary embodiment of the present invention, the controller 720 (i.e. register) of the data conversion apparatus 420 may be set in an initial stage (e.g., at a boot and/or start of a system) and/or when a system connected to the data processing apparatus 400 is changed.

In another exemplary embodiment of the present invention, referring to FIG. 6, in 810, a user of the first system 400 including the data conversion apparatus 420 may determine whether the endian format used in the first system 400 matches the endian format used in at least one second system transferring data with the first system.

In another exemplary embodiment of the present invention, if the endian format used in the first system 400 matches the endian format of the data used in the second system (e.g., both formats are either big-endian or little-endian), the controller 720 may be set to a given value (e.g., a high logic state ‘1’ or a low logic state ‘0’) in 820, the given value indicating the format for the two systems.

In another exemplary embodiment of the present invention, the endian conversion circuits 730 and 740 may be inactivated (i.e., set to perform no conversion) in response to the given value of the controller 720.

In another exemplary embodiment of the present invention, if the endian format used in the first system 400 is different from the endian format used in the second system (e.g., one of the systems includes big-endian and the other includes little-endian), the controller 720 may be set to a given value (e.g., a high logic state ‘1’ or a low logic state ‘0’) in 830. The given value may indicate to each of the endian conversion circuit 730 and 740 whether to convert from big-endian to little-endian and/or from little-endian to big-endian.

In another exemplary embodiment of the present invention, consistent with above-described embodiments, the data conversion apparatus 400 may not require software for a data format conversion. Thus, a time required to perform data format conversion may be reduced. Further, the processing speed of a data processing system may be increased, since processing may not be required for the data conversion at a software level.

In another exemplary embodiment of the present invention, consistent with above described embodiments, a single setting of a controller may be set by a user to initiate a software-free (i.e., hardware) data conversion.

The exemplary embodiments of the present invention being thus described, it will be obvious that the same may be varied in many ways. For example, the control signal (i.e. from the register or controller 720) may be configured as either a high logic state or a low logic state to indicate whether or not a data conversion may occur.

While above exemplary embodiments have been directed to little-endian data and big-endian data, any type of data format conventionally converted with software may be converted without software according to exemplary embodiments of the present invention.

Such variations are not to be regarded as departure from the spirit and scope of the example embodiments of the present invention, and all such modifications as would be obvious to one skilled in the art are intended to be included within the scope of the following claims.

1. A data conversion apparatus, comprising:
a protocol conversion device for receiving a first data with a first protocol at one or more of a plurality of input ports and converting the received first data into a second protocol without requiring software processing.

2. The data conversion apparatus of claim 1, wherein the protocol conversion device further comprises:
a plurality of output ports, at least one of the plurality of output ports outputting the converted first data with the second protocol.

3. The data conversion apparatus of claim 2, further comprising:
a first endian converter and a second endian converter, the first and second endian converters for receiving the converted first data with a first endian format from the at least one of the plurality of output ports, converting the converted first data into a second endian format, and outputting the converted first data with the second endian format.

4. The data conversion device of claim 1, wherein at least one of the first and second protocols is an open core protocol.

5. The data conversion device of claim 1, wherein at least one of the first and second protocols is an advanced microcontroller bus architecture protocol.

6. The data conversion apparatus of claim 3, wherein at least one of the first and second endian formats is a little-endian format.

7. The data conversion apparatus of claim 3, wherein at least one of the first and second endian formats is a big-endian format.

8. The data conversion apparatus of claim 3, wherein the first endian format is a little-endian format.

9. The data conversion apparatus of claim 3, wherein the second endian format is a big-endian format.

10. The data conversion apparatus of claim 3, wherein a control signal determines a data format conversion for each of the first and second endian converters.

11. A data conversion apparatus, comprising:
a first endian converter for converting first data with a first data format and a first protocol into a second data format in response to a control signal;
a second endian converter for converting second data with a second data format and the first protocol into a first data format in response to the control signal; and
a protocol converter for converting at least one of the first and second data from a second protocol to the first protocol.

12. The data conversion apparatus of claim 11, wherein the first data format is a big-endian format and the second data format is a little-endian format.

13. The data conversion apparatus of claim 11, wherein the first endian format is a little-endian format and the second endian format is a big-endian format.

14. The data conversion apparatus of claim 11, wherein the protocol converter outputs the first data to the first endian converter and the second data to the second endian converter.

15. The data conversion apparatus of claim 11, wherein the first endian converter performs at least one of converting the first data from the first data format into the second data format and not converting the data format of the first data based on the control signal.

16. The apparatus of claim 11, wherein the second endian converter performs at least one of converting the second data from the second data format into the first data format and not converting the data format of the second data based on the control signal.

17. The apparatus of claim 11, further comprising:
a controller outputting the control signal.

18. A data conversion apparatus comprising:
a first endian converter for performing at least one of converting big-endian data into little-endian data and not performing a data format conversion based on a control signal;
a second endian converter for performing at least one of converting little-endian data into big-endian data and not performing a data format conversion based on the control signal; and
a protocol converter for converting first big-endian data complying with a first protocol into first big-endian data complying with a second protocol, outputting the converted first big-endian data to the first endian converter, converting second little-endian data complying with the second protocol into second little-endian data complying with the first protocol, and outputting the converted second little-endian data to the second endian converter.

19. A data processing system, comprising:
a data conversion apparatus for outputting first data including at least one of a first data transmission format and a second data transmission format, the outputted data transmission format of the first data being based on a control signal, and not being based on a received data transmission format; and
an external system for transferring second data with the data conversation apparatus, the second data including at least one of the first data transmission format and the second data transmission format.

20. The data processing system of claim 19, wherein the data conversion apparatus comprises:
a controller generating the control signal;
a first data transmission format conversion circuit for converting data of the first data transmission format into data of the second data transmission format based on the control signal and for transmitting at least one of the converted data and the data of the first data transmission format to the external system.

21. The data processing system of claim 20, wherein the data conversion apparatus further comprises:
a second data transmission format conversion circuit for converting data of the second data transmission format into data of the first data transmission format based on the control signal and for transmitting at least one of the converted data and the first data transmission format to the external system.

22. The data processing system of claim 21, further comprising:
a protocol converter for converting the data received from the external system, the data having a first data transmission format complying with a first protocol, into data having the first data transmission format complying with a second protocol.

23. The data processing system of claim 22, wherein the protocol converter outputs the converted data to the first data transmission format conversion circuit, converts the data output to the external system and complying with the second protocol, into data complying with the first protocol, and outputs the converted data to the input terminal of the second data transmission format conversion circuit.

24. The data processing system of claim 19, wherein the first data transmission format is big-endian and the second data transmission format is little-endian.

25. The data processing system of claim 19, wherein the first data transmission format is little-endian and the second data transmission format is big-endian.

26. A method for converting data transmission formats, comprising:
generating a control signal based on a data transmission format used by an external system; and
configuring a first data transmission format conversion circuit to convert received first data including a first data transmission format into a second data transmission format in response to a control signal.

27. The method of claim 26, further comprising:
configuring a second data transmission format conversion circuit to convert received second data including a second data transmission format into a first data transmission format in response to a control signal.

28. The method of claim 26, further comprising:
outputting the converted first data with the second data transmission format.

29. The method of claim 27, further comprising:
outputting the converted second data with the first data transmission format.

30. The method of claim 27, wherein the first data transmission format is big-endian and the second data transmission format is little-endian.

31. The method of claim 27, wherein the first data transmission format is little-endian and the second data transmission format is big-endian.

32. A method of data format conversion, comprising:
receiving data with a first data format; and
converting the data into a second data format without requiring software processing.

33. The method of claim 32, wherein the first data format is little-endian and the second data format is big-endian.

34. The method of claim 32, wherein the first data format is big-endian and the second data format is little-endian.

35. A method of data protocol conversion, comprising:
receiving data with a first data protocol; and
converting the data into a second data protocol without requiring software processing.

36. The method of claim 35, wherein at least one of the first data protocol and the second data protocol is an open core protocol.

37. The method of claim 35, wherein at least one of the first data protocol and the second data protocol is an advanced microcontroller bus architecture protocol.

38. A data conversion apparatus for performing the method of claim 26.

39. A data conversion apparatus for performing the method of claim 32.

40. A data conversion apparatus for performing the method of claim 35.

41. A data processing system for performing the method of claim 32.
